(19) United States
(12) Patent Application Publication
(10) Pub. No.: US 2019/0018710 A1
(43) Pub. Date: Jan. 17, 2019

(54) MANAGING RESOURCE ALLOCATION OF A MANAGED SYSTEM

(71) Applicant: NICIRA, INC., Palo Alto, CA (US)

(72) Inventors: PRASHANT AMBARDEKAR, Pune (IN); Prayas Gaurav, Pune (IN); James Joseph Stabile, Palo Alto, CA (US); Steven Peters, Palo Alto, CA (US)

(21) Appl. No.: 15/810,159

(22) Filed: Nov. 13, 2017

(30) Foreign Application Priority Data
Jul. 11, 2017 (IN) 201741024345

(51) Int. Cl. G06F 9/50; G06F 9/455; H04L 29/12

(52) U.S. Cl. CPC G06F 9/5077; G06F 9/5011; G06F 9/45558; H04L 67/10; H04L 61/2007; H04L 61/6022; H04L 61/2061

(57) ABSTRACT

In a computer-implemented method for managing resource allocation of a managed system, responsive to a request by a consumer node, an owner node of a plurality of owner nodes that controls resource allocations from the pool of resources is determined, where the resource is associated with a data object. A resource is allocated from a pool of resources comprising a plurality of resources by the owner node. An allocation marker corresponding to the resource is created. The resource and the allocation marker are made available for retrieval by the consumer node.

### RELATED APPLICATION

Benefit is claimed under 35 U.S.C. 119(a)-(d) to Foreign Application Serial No. 201741024345 filed in India entitled “MANAGING RESOURCE ALLOCATION OF A MANAGED SYSTEM”, filed on Jul. 11, 2017, by Nicira, Inc., which is herein incorporated in its entirety by reference for all purposes.

### BACKGROUND

Many types of distributed systems, such as software defined networks (SDNs), provide for data object creation that includes the allocation of resources. For example, creation of data objects such as logical networks and logical routers requires resources such as Internet Protocol (IP) addresses and media access control (MAC) addresses. Moreover, resource allocation typically needs to provide unique resources, prevent resource leakage, and have minimal impact on performance.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Herein, like items are labeled with like item numbers.

FIG. 1 shows an example software defined network (SDN) upon which embodiments of the present invention can be implemented.

FIG. 2 shows an example system manager including multiple nodes, in accordance with various embodiments.

FIG. 3 shows an example database table and an example resource allocation table, in accordance with various embodiments.

FIGS. 4A-C illustrate flow diagrams of an example method for managing resource allocation of a managed system, according to various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “allocating,” “creating,” “making,” “receiving,” “deleting,” “saving,” “communicating,” “returning,” or the like, refer to the actions and processes of an electronic computing device or system such as: a host processor, a processor, a memory, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance (e.g., serviceability and correctness) of computer systems by improving the management of resource allocation in a managed system. In accordance with the described embodiments, data objects refer to data structures that are representative of attributes of components or logical entities of a system. For example, data objects may include attributes of a component, configuration settings, or state information of a component or logical entity.

Embodiments described herein provide for improved management of resource allocation for data objects. For example, in a virtual networking environment, resource allocation includes the allocation of IP addresses and MAC addresses. In order to ensure proper performance of the virtual network (e.g., a logical overlay network), the allocated IP addresses and MAC addresses must be unique. Moreover, resource leakage can occur if a resource gets allocated to a data object but remains unused (e.g., the consumer node crashes before saving the allocated resource). In such a situation, a resource is allocated and unused, limiting the availability of resources and consuming memory associated with the allocation. The described embodiments provide for resource allocation to data objects in a distributed system ensuring unique resource allocation and preventing or minimizing resource leakage, while minimally impacting performance of the managed system.

In accordance with some embodiments, in multiple nodes of a system manager manage resource allocation for pools of resources, where each pool of resource is managed by a particular node (e.g., an owner node). Responsive to a request to allocate a resource by a consumer node, an owner node of a plurality of owner nodes that controls resource allocations from a pool of resources is determined, where the resource is associated with a data object. In various embodiments, the resource is one of an IP address, a MAC address, and a device identifier (e.g., router ID or switch ID). A resource is allocated from a pool of resources including a plurality of resources by the owner node. An allocation marker corresponding to the resource is created. The allocation marker indicates that the allocation of the resource is temporary. The resource and the allocation marker are made available for retrieval by the consumer node.

In one embodiment, the resource is received at the consumer node and the allocation maker is deleted. Deleting the allocation marking indicates that the allocation is permanent, in one embodiment, the resource is saved in a resource allocation table at the consumer node. In one embodiment, the allocation marker is deleted and the resource is saved in a resource allocation table at the consumer node in a single transaction.

In one embodiment, the allocation marker includes a time stamp (e.g., indicating the time the resource was created or indicating the time the resource was made available for retrieval). In one embodiment, provided the resource and the allocation marker are not retrieved by the consumer node before an expiry interval after the time stamp lapses, the resource is returned to the pool of resources, such that the resource is available for allocation.

In accordance with various embodiments, the managed system includes a virtualized environment. For many types of virtualized environments implementing virtual networking, SDN managers, such as VMware Inc.'s NSX Manager, are used to manage operations. SDN managers provide configuration management for components (e.g., hosts, virtual servers, VMs, data end nodes, etc.) of the virtualized environment. To effectuate management of the SDN, SDN managers are configured to manage and/or utilize data objects. Data objects within a virtualized environment (e.g., a virtualization infrastructure) may require the allocation of various resources to operate.

### Example System for Managing Resource Allocation of a Managed System

Example embodiments described herein provide systems and methods for managing resource allocation of a managed system. In accordance with some embodiments, responsive to a request to allocate a resource by a consumer node, an owner node of a plurality of owner nodes that controls resource allocations from the pool of resources is determined, where the resource is associated with a data object. A resource is allocated from a pool of resources including a plurality of resources by the owner node. An allocation marker corresponding to the resource is created. The resource and the allocation marker are made available for retrieval by the consumer node.

In one embodiment, the resource and the allocation marker are received at the consumer node and the allocation marker is deleted. In one embodiment, the resource is saved in a resource allocation table at the consumer node. In one embodiment, the allocation marker is deleted and the resource is saved in a resource allocation table at the consumer node in a single transaction.

In one embodiment, the allocation marker includes a time stamp. In one embodiment, provided the resource and the allocation marker are not retrieved by the consumer node before an expiry interval after the time stamp lapses, the resource is returned to the pool of resources, such that the resource is available for allocation.

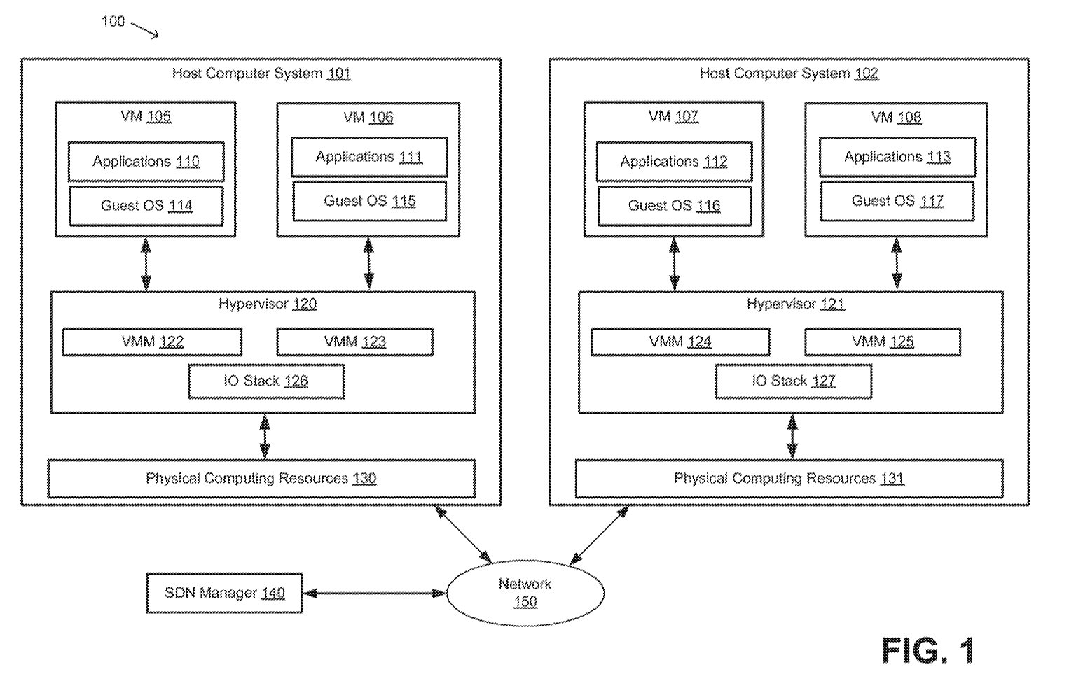

FIG. 1 shows an example physical datacenter 100 upon which embodiments of the present invention can be implemented. Software defined networking allows for virtual networking and security operations in a virtualization infrastructure. As illustrated, datacenter 100 includes host computer system 101 and host computer system 102 that are communicatively coupled to SDN manager 140 via network 150. Host computer systems 101 and 102 are configured to implement logical overlay networks that are logical constructs that are decoupled from the underlying hardware network infrastructure. Logical overlay networks comprise logical ports, logical switches, logical routers, etc. Each logical overlay network is decoupled from the physical underlying infrastructure by encapsulation of overlay network packets, e.g., using an encapsulation protocol such as VXLAN or Geneve, before transmitting the data packet over physical network 150.

While datacenter 100 is illustrated with two host computer systems, each implementing two virtual machines, it should be appreciated that embodiments described herein may utilize any number of host computer systems implementing any number of virtual machines. Moreover, while embodiments of the present invention are described within the context of datacenter for implementing a virtualization infrastructure, it should be appreciated that embodiments of the present invention may be implemented within any managed system including data objects.

Virtualized computer systems are implemented in host computer systems 101 includes physical computing resources 130 and host computer system 102 includes physical computing resources 131. In one embodiment, host computer systems 101 and 102 are constructed on a conventional, typically server-class, hardware platform.

In accordance with various embodiments, physical computing resources 130 and 131 include one or more central processing units (CPUs), system memory, and storage. Physical computing resources 130 and 131 may also include one or more network interface controllers (NICs) that connect host computer systems 101 and 102 to network 150.

Hypervisor 120 is installed on physical computing resources 130 and hypervisor 121 is installed on physical computing resources 131. Hypervisors 120 and 121 support a virtual machine execution space within which one or more virtual machines (VMs) may be concurrently instantiated and executed. Each virtual machine implements a virtual hardware platform that supports the installation of a guest operating system (OS) which is capable of executing applications. For example, virtual hardware for virtual machine 105 supports the installation of guest OS 114 which is capable of executing applications 110 within virtual machine 105. Similarly, virtual machine 106 supports the installation of guest QS 115 which is capable of executing applications 111 within virtual machine 106, virtual machine 107 supports the installation of guest OS 116 which is capable of executing applications 112 within virtual machine 107, and virtual machine 108 supports the installation of guest OS 117 which is capable of executing applications 113 within virtual machine 108.

In an alternate embodiment (not shown) some or all of applications 110-113 reside in namespace containers implemented by a bare-metal operating system or an operating system residing in a virtual machine. Each namespace container provides an isolated execution space for containerized applications, such as Docker® containers, each of which may have its own unique IP and MAC address that is accessible via a logical overlay network implemented by underlying hypervisor if it exists or by the host operating system.

Virtual machine monitors (VMM) 122 and 123 may be considered separate virtualization components between the virtual machines and hypervisor 120 since there exists a separate VMM for each instantiated VM. Similarly, VMM 124 and VMM 125 are separate virtualization components between the virtual machines and hypervisor 121. Alternatively, each VMM may be considered to be a component of its corresponding virtual machine since such VMM includes the emulation software for virtual hardware components, such as I/O devices, memory, and virtual processors, for the virtual machine, and maintains the state of these virtual hardware components. It should also be recognized that the techniques described herein are also applicable to hosted virtualized computer systems.

In various embodiments, SDN manager 140 provides control for logical networking services such as a logical firewall, logical load balancing, logical layer 3 routing, and logical switching. In some embodiments, SDN manager 140 is able to create and manage data objects of a logical overlay network, such as logical routers. Logical network services may be allocated associated resources that are necessary for performing the services' respective operations. For example, logical routers may be allocated resources such as IP addresses and MAC addresses. To ensure proper configuration and operation of a logical network, these allocated resources typically must be unique.

In accordance with various embodiments, workloads are communicated over a logical overlay network. Examples of a workload, as used herein, include an application, a virtual machine, or a container, etc. For example, a workload may include implementing a web server, implementing a web server farm, implementing a multilayer application, etc.

In various embodiments, a logical overlay network, using at least one of hypervisor 120 and 121, may include Layer 2 through Layer 7 networking services (e.g., switching, routing, access control, firewalling, quality of service (QoS), and load balancing) whose configuration and/or state may be represented by data objects. Accordingly, these data objects may be assembled and/or manipulated (e.g., by a networking administrator programmatically, via a graphical user interface, command line interface, etc.) in any combination, to produce individual logical overlay networks. As previously mentioned, logical overlay networks are independent of underlying network hardware (e.g., physical computing resources 130 and 131), allowing for network hardware to be treated as a networking resource pool that can be allocated and repurposed as needed.

Logical switches and logical routers are examples of services that may be represented by data objects for resource allocation. A logical switch creates a logical broadcast domain or segment to which an application or tenant VM can be logically wired. A logical switch may provide the characteristics of a physical switch's broadcast domain. In some embodiments, a logical switch is distributed and can span arbitrarily large compute clusters. For example, logical overlay network allows a VM to migrate within its datacenter without limitations of the physical Layer 2 boundary. A logical router provides the necessary forwarding information between logical Layer 2 broadcast domains.

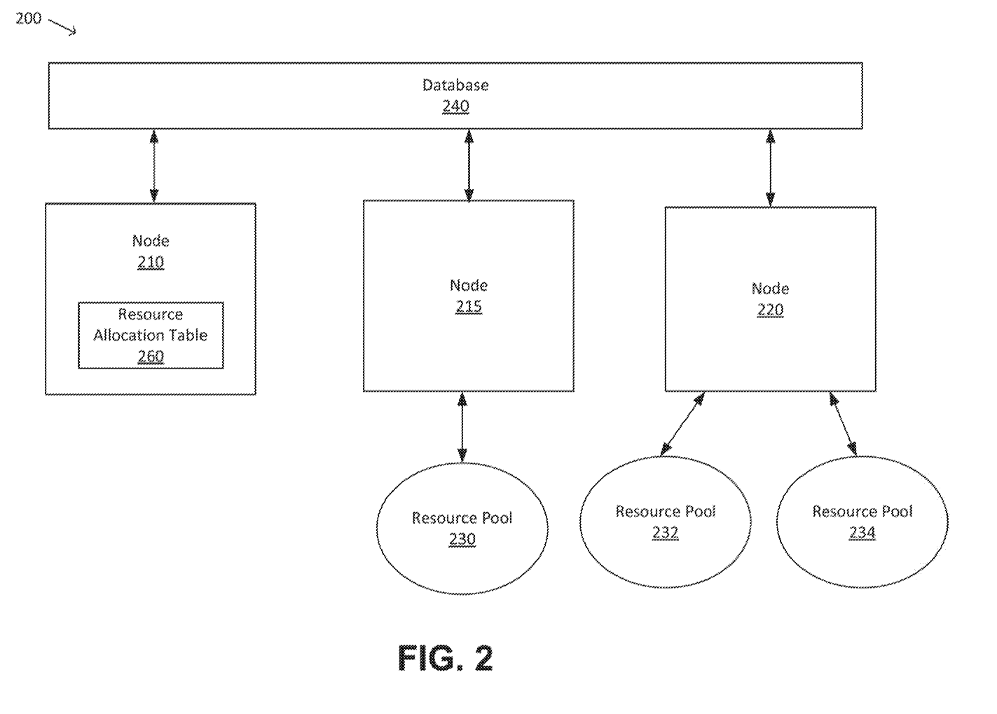

FIG. 2 shows an example multi-node system manager 200, in accordance with various embodiments. System manager 200 is used to manage operations of a managed system and provides for configuration management for components of the managed system. In one embodiment, system manager 200 is an SDN manager (e.g., SDN manager 140 of FIG. 1) and is used to manage virtualized networking operations and provides configuration management for components (e.g., logical switches, logical routers, hosts, virtual servers, VMs, data end nodes, etc.) of the virtualized environment. Data objects are used by system manager 200 in managing the virtual environment (e.g., for managing a logical overlay network) that is decoupled from the physical underlying infrastructure (e.g., datacenter 100).

Multi-node system manager 200 allows for distributed management and configuration of components of the managed system. In accordance with the described embodiments, system manager 200 provides for the allocation of resources used in performing and creating logical overlay networks, such as IP addresses, MAC addresses, and device IDs. System manager 200 provides for allocation of these resources from an available range or ranges of resources. In order to ensure proper operation of a logical overlay network, resource allocation provides unique resources, prevents resource leakage, and provides throughput such that performance of the managed system is not degraded.

As used herein, unique resources means that resources allocated to data objects are unique such that a resource (e.g., an IP address or a MAC address) is only allocated to one data object at any given time. In the event that a particular resource is no longer used, it can be returned to a pool of resources for allocation to another data object. Multi-node system manager 200 provides for the creation of logical routers and logical switches on any node. Ensuring uniqueness of resources is of particular importance in a distributed system. For instance, where multiple nodes are able to allocate resources concurrently, management of unique resource allocation can be burdensome.

Moreover, resource leakage can occur if a resource gets allocated to a data object but the consumer node crashes before saving the allocated resource in its database. In such a situation, a resource is allocated and unused, limiting the availability of resources and consuming memory associated with the allocation. The described embodiments provide for resource allocation to data objects in a distributed system ensuring unique resource allocation and preventing or minimizing resource leakage, while minimally impacting performance of the managed system.

System manager 200 includes node 210, node 215, and node 220, each of which is communicatively coupled to database 240. As illustrated, node 210 includes resource allocation table 260, node 215 manages allocation of resources for resource pool 230, and node 220 manages allocation of resources for resource pool 232 and resource pool 234. As utilized herein, an “owner” node refers to a node that manages a pool of resources and a “consumer” node refers to a node that requests a resource for allocation. It should be appreciated that a node (e.g., node 210, 215, and 220) can operate as an owner node, a consumer node, or both an owner node and consumer node, depending on the functionality assigned to the node. For example, node 215 may operate as an owner node by allocating a resource from resource pool 230 to node 210 and also operate as a consumer node by requesting the allocation of a resource from resource pool 232 managed by node 220. It should also be appreciated that system manager 200 can include any number of nodes.

Resource pools 230, 232, and 234 are pools of resources that include resources that may be allocated to data objects response to a request. For instance, data objects such as a data object representing a configuration and/or state of a logical router and/or logical switch require resources such as IP address, MAC addresses, Virtual Extensible Local Area Network (VXLAN) Network Identifiers (VNIs), and device IDs (e.g., routers IDs and switch IDs). These resources are maintained in resource pools for allocation. For example, resource pool 230 managed by node 215 may be a pool of IP addresses and resource pool 232 managed by node 220 may also be a pool of IP addresses. It should be appreciated that where resource pools include the same type of resource, these resource pools include different allocable resources in order to preserve uniqueness of resources. For example, where resource pools 230 and 232 are pools of IP addresses, resource pool 230 may include a range of allocable IP addresses such as 192.168.1.10-192.168.1.50, while resource pool 232 may include a range of allocable IP addresses such as 192.168.1.110-192.168.1.255. It should be appreciated that resource pools can include any number of resources that can be a different number of resources from other resource pools for the same type of resource. Moreover, it should be appreciated that a node may manage any number of resource pools, including multiple resource pools for the same type of resource.

In accordance with various embodiments, resource pool creation and lifecycle is managed by a resource allocation system. For instance, ranges of resource maintained with resource pools may have two version. For example, a range of resources may include all IP addresses within the range of 192.168.1.10-192.168.1.50. A first version may store string values for range start and end and a second version may store number representations and allocation details (partitions and allocated resource bitset). When resource pools and ranges are created, each range will be internally divided into partitions. Each partition will be backed by a bitset of size equal to size of the partition, where each partition has partition number, partition size and the bitset representing allocation. A bitset is a data structure (e.g., an array) of bits where each bit in the data structure can be set, unset, and/or queried. In one embodiment, the bitset is a Java bitset.

In various embodiments, a resource pool of IP addresses includes a collection of one or more embeddable subnets. In some embodiments, the embeddable subnets also have embeddable ranges. The embeddable subnets and embeddable ranges need not include contiguous address space. An embeddable subnet is a set of IPv4 or IPv6 addresses defined by a start address and a mask/prefix which will be associated with a layer-2 broadcast domain and will typically have a default gateway address on a layer-3 router. It should be appreciated that there may be one or more embeddable subnets of either protocol (IPv4 or IPv6) on a given layer-2 broadcast domain. An example embeddable subnet is 10.1.1.0/24. Embeddable subnets can be created when a resource pool of IP addresses is created. An embeddable range is a set of IPv4 or IPv6 addresses defined by a start and end address. An embeddable range can be used for either static or dynamic (DHCP) allocation of addresses to virtual machines.

Embodiments described herein provide for resource allocation using a single writer mechanism. A single writer mechanism dictates that each resource pool has a designated node that manages resource allocation, also referred to herein as an “owner node.” This ensures that a resource pool is updated (e.g., resources allocated) by one node at any time. As such, simultaneous updates to the same resource pool from multiple nodes are not available. All allocation requests for a particular resource pool are redirected to the owner node responsible for resource allocation for that resource pool.

In various embodiments, the resource allocation system uses a single writer mechanism to channel allocation and deallocation requests for a particular resource pool to the owner node of that resource pool. Read and modify requests can be serviced from any node. For example, a consumer nodes requests for the resource allocation system to allocate an IP address from an IP pool. The resource allocation system calls on the owner node to IP address from the IP pool. The resource allocation system uses a single writer mechanism to channel the allocation request to the owner node of the pool, while allowing other nodes to process and handle other allocation requests. The single writer mechanism executes the call on the owner node of the resource pool. A new allocation is made and result is returned to the consumer node.

In accordance with various embodiments, resource allocation is performed responsive to a node (e.g., node 210), also referred to as a “consumer node,” requesting the allocation of a resource to a data object. The owner node (e.g., node 220) allocates a resource from a resource pool (e.g., resource pool 232) and creates an allocation marker to track this allocation. For example, the allocated resource and the allocation marker are saved in database (e.g., database 240) accessible to the owner node and the consumer node. It should be appreciated, in accordance with various embodiments, that the database is a distributed database. In one embodiment, the allocated resource and the allocation marker are saved in the database in a single transaction. In some embodiments, the allocation marker includes a time stamp. Allocated resources having an associated allocation marker are considered temporary allocations and are subject to garbage collection and return to the resource pool if an expiry period after the time stamp lapses to prevent resource leakage.

In one embodiment, the owner node allocates any free resource of the type requested. The owner node determines the ranges of resources available for the resource pool. The range may be shuffled to be arranged in random order for increasing the concurrency. For each range, it is determined whether the range is fully allocated. If so, the determination is made for a next range. If the range is not fully allocated, partitions within the range are shuffle to be arranged in a random order for increasing concurrency. For each partition, the next free resource is determined. If no resource is free, a next partition is checked for a free resource. If a free resource is found, the resource is allocated by setting a bit (e.g., set the bit to be allocated in this partition). The allocation marker is updated with the allocated resource and a confirmation flag is set to false, and the allocation marker and confirmation flag are saved to a database. The updated partition including the allocated resource is saved to the database. For example, from the bit index (e.g., from the bitset) the corresponding resource can be located within the range (e.g., range start+size of partition*number of partitions to skip+offset into the allocated partition). The resource is then returned to the requesting node (e.g., consumer node). If no free resource is found, a null value is returned.

In another embodiment, the owner node allocates a specific resource of the type requested. The owner node determines the ranges of resources available for the resource pool. For each range, it is determined whether the specific resource belongs to the range. If not, the determination is made for a next range. If the specific resource belongs to the range, partitions within the range are retrieved. For each partition, it is determined whether the specific resource belongs to the partition. If not, a next partition is checked for the specific resource. If the specific resource is found within a partition, the resource is allocated by setting a bit (e.g., set the bit to be allocated in this partition). The allocation marker is updated with the allocated resource and a confirmation flag is set to false, and the allocation marker and confirmation flag are saved to a database. The updated partition including the allocated resource is saved to the database. For example, from the bit index the corresponding resource can be located within the range (e.g., range start+size of partition*number of partitions to skip+offset into the allocated partition). The specific resource is then returned to the requesting node (e.g., consumer node). If the specific resource found, a null value is returned.

Once the allocated resource and the allocation marker are saved in database, the consumer node retrieves the allocated resource and saves the allocated resource in its allocation tables (e.g., resource allocation table 260) and marks the allocation as permanent. In one embodiment, the allocation is marked permanent by deleting the allocation marker. In one embodiment, the saving of the allocated resource in its allocation tables and the deletion of the allocation marker are performed in a single transaction. For example, if the consumer node crashes prior to making the allocation permanent, the allocation marker is not deleted, and the resource may be returned to the resource pool responsive it the lapsing of the expiry period.

Still with reference to FIG. 2, the following is a description of an example resource allocation in accordance with an embodiment. In the current example, node 210 requests the allocation of an IP address from resource pool 232, where resource pool 232 is a pool of IP addresses. A request object is created by node 210 and saved in database 240. Responsive to the request object being saved in database 240, a change notification is generated in all nodes of system manager 200. Each node (e.g., node 210, node 215, and node 220) determines whether it is the owner node of resource pool 232. Nodes 210 and 215, determining they are not the owner node of resource pool 232, take no further action to the change notification. Node 220, determining that it is the owner node of resource pool 232, performs the IP address resource allocation and updates the request object with the allocated IP address. Node 220, contemporaneously to updating the request object, creates an allocation marker corresponding to the allocated IP address and saves the allocation marker to the database 240. In one embodiment, the request object is updated in the database 240 and the allocation marker is saved in the database 240 in a single transaction.

Continuing with the example, in some embodiments, a garbage collection operation is periodically performed. In one embodiment, the garbage collection is a background task of the resource allocation operation. For instance, where the allocation marker includes a time stamp indicating when the allocation marker was created, the garbage collection operation will determine whether an expiry interval (e.g., 5 minutes or 30 minutes) has lapsed since the time indicated by the time stamp. If the expiry interval is determined to have lapsed, the garbage collection operation returns the allocated resource to its originating resource pool, resource pool 232 in the current example, for allocation to a requesting node.

In accordance with various embodiments, a resource may be freed from allocation. From the resource pool, all ranges of the resources are retrieved. For each range, it is determined whether the resource belongs to that range. If not, the determination is made for a next range. If the resource belongs to the range, partitions within the range are retrieved. For each partition, it is determined whether the resource belongs to that partition. If not, the determination is made for a next partition. If the resource belongs to the partition, the corresponding index bit is unset. The updated partition is then saved to the database.

Node 210 will receive a notification that the request object in database 240 has been updated with the requested resource, and will fetch the allocated IP address from the request object. Node 210 consumes the allocated IP address and deletes the allocation marker associated with the allocated IP address, marking the allocation as permanent. In one embodiment, the consumption of the IP address and the deletion of the allocation marker are performed in a single transaction.

It should be appreciated that if node 210 crashes prior to fetching the allocated IP address, but after node 220 has updated the request object indicating that the resource has been allocated, the allocated IP address could be allocated and unused because node 220 did not consume the IP address, thus creating a resource leak. The allocation marker prevents a resource leak since the allocated IP address is subject to garbage collection until the IP address is consumed by node 220.

It should be appreciated that only one of the allocation operation and garbage collection operation should succeed. If a resource allocation is made permanent by deleting the allocation marker, the garbage collection operation will fail for the associated allocated resource. This failure would be ignored by system manager 200. Alternatively, if the garbage collection operation succeeds and the resource is returned to the originating resource pool for allocation, the allocation operation fails and node 210 will initiate another resource allocation operation to receive a resource. In certain circumstances, a conflict may arise if the allocation operation and the garbage collection operation are attempted at the same time (e.g., if the system is operating slowly or the expiry period is too short). In such a circumstance, if the allocation operation fails, the allocation operation is reattempted. If the garbage collection operation fails the failure is ignored as the resource has already been allocated and is in use by the consumer node.

In accordance with various embodiments, a resource allocation may be permanent according to the follow. From the resource pool, all ranges of the resources are retrieved. For each range, it is determined whether the resource belongs to that range (e.g., if the resource lies between the start and the end of the range). The allocation marker is found for the corresponding resource. If the resource is found, the confirmation flag is set to true. Garbage collection will clean up allocation markers for resources that have the confirmation flag set to true.

In accordance with various embodiments, resources with allocation markers having lapsed an expiry period after the time stamp of the allocation marker are returned to the resource pool as follows. For each resource pool, the allocated resources are determined. For every allocated resource with a confirmation flag set to false, it is determined whether the expiry period after the time stamp of the allocation marker has lapsed. If the period after the time stamp of the allocation marker has lapse, the resource is released from the database, resulting in the bit of the partition for the resource being unset and the allocation marker being deleted. Unsetting the bit and deleting the allocation marker are performed in a single transaction.

In some embodiments, garbage collection may also be performed to locate and delete allocation markers with the confirmation flag set to true, as the allocation marker is no longer needed. This is performed without returning the resource to the resource pool, as the allocation has been marked as permanent.

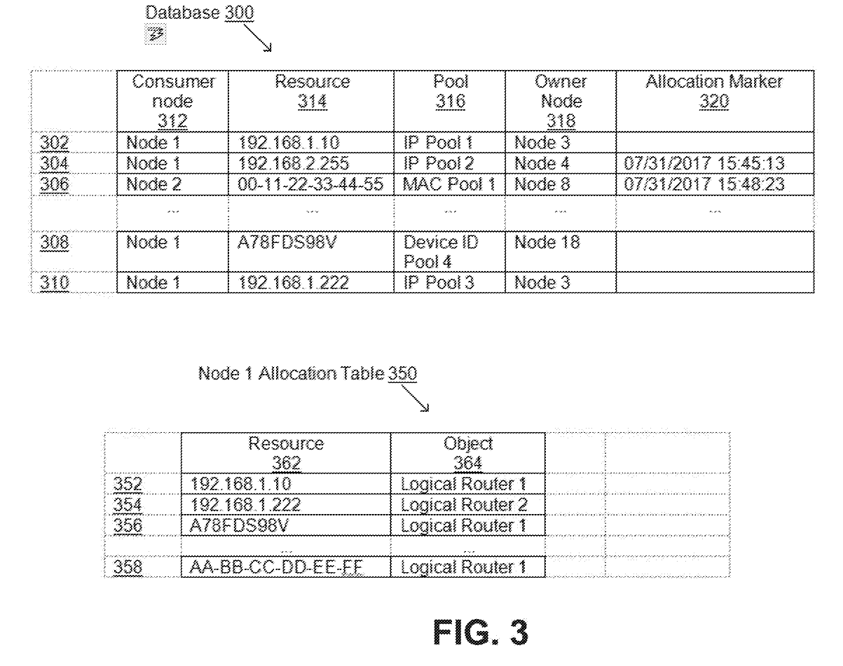

FIG. 3 shows an example database table 300 and an example resource allocation table 350, in accordance with various embodiments. It should be appreciated that the names and amount of nodes and resource pool are examples, and that any number of nodes and resource pools can be used. With reference to database table 300, lines 302, 304, 306, 308, and 310 include resource allocation information for each allocated resource 314, including consumer node 312, resource pool 316, owner node 318, and allocation marker 320. For example, line 302 indicates that IP address 192.168.1.10 is allocated to node 1 from IP pool 1 managed by owner node 3. There is no allocation marker 320 in line 302, indicating that allocated resource 314 of line 302 is permanent. Line 304 indicates that IP address 192.168.2.255 is allocated to node 1 from IP pool 2 managed by owner node 4. The allocation marker 320 in line 304 indicates that the allocation is temporary as not yet having been retrieved by node 1. Line 306 is an example temporary resource allocation for a MAC address, line 308 is an example permanent resource allocation for a device ID, and line 310 includes another example of permanent resource allocation for an IP address.

Resource allocation table 350 is an example resource allocation table for node 1 as indicated in database table 300. It should be appreciated that the names and amount of resources and objects are examples, and that any number of resources and objects can be used. Lines 352, 354, 356, and 358 include an allocated resource 362 and an object 364 associated with the allocated resource. For example, line 352 indicates that IP address 192.168.1.10 is associated with logical router 1. The information in line 352 corresponds to line 302 of database table 300. With reference to line 304 of database table 300, the resource 314 of line 304 is not referred to in resource allocation table 350, as the allocation is still temporary as indicated by the allocation marker 320. Lines 354, 356, and 358 of resource allocation table 350 include other examples of allocated resources and associated objects. For example, line 356 corresponds to line 308 of database table 300.

### Example Methods of Operation

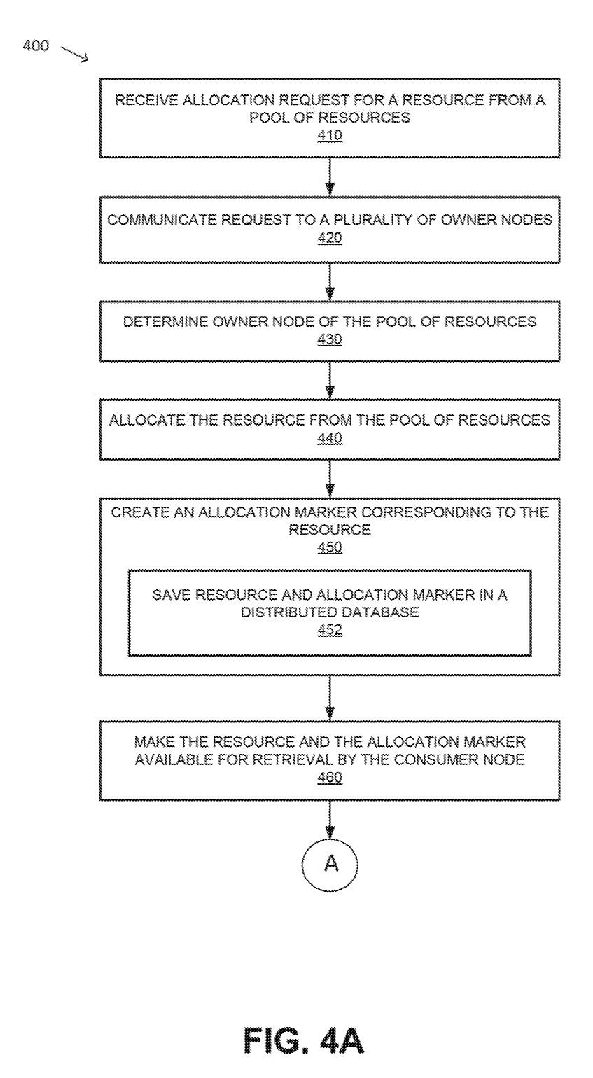

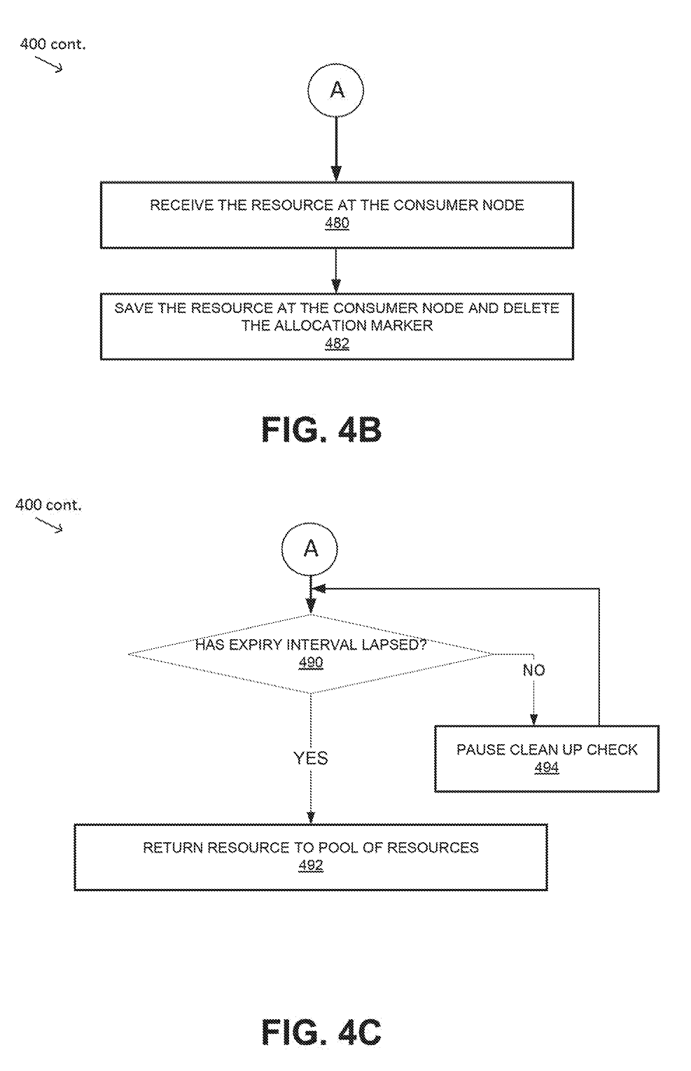

FIGS. 4A-C illustrate flow diagrams 400 of an example method for managing resource allocation of a managed system, according to various embodiments. Procedures of this method will be described with reference to elements and/or components of FIG. 2. It is appreciated that in some embodiments, the procedures may be performed in a different order than described, that some of the described procedures may not be performed, and/or that one or more additional procedures to those described may be performed. Flow diagram 400 includes some procedures that, in various embodiments, are carried out by one or more processors under the control of computer-readable and computer-executable instructions that are stored on non-transitory computer-readable storage media. It is further appreciated that one or more procedures described in flow diagram 400 may be implemented in hardware, or a combination of hardware with firmware and/or software.

In accordance with one embodiment, at procedure 410 of flow diagram 400, a request by the consumer node (e.g., node 210) to allocate a resource from a pool of resources (e.g., resource pool 234) is received at a database (e.g., database 240) of a managed system. In various embodiments, the resource is one of an IP address, a MAC address, and a device identifier (e.g., router ID or switch ID). In some embodiments, the managed system includes a plurality of owner nodes (e.g., nodes 215 and 220), wherein each owner node controls allocation of resources from a designated pool of resources (e.g., resource pools 230, 232, and 234).

In one embodiment, at procedure 420, a change notification is communicated to the plurality of owner nodes, where the change notification includes the request. The change notification may be communicated by the database. For example, the database may be configured such that changes including requests for resource allocation result in the creation and communication of a change notification that is broadcast to all nodes (or a subset of nodes) of the managed system.

At procedure 430, responsive to the request by a consumer node for a resource from a pool of resources, an owner node of a plurality of owner nodes that controls resource allocations from the pool of resources is determined, where the resource is associated with a data object. For example, each node receiving the change notification determines whether it is the owner of the pool of resources including the requested resource. In accordance with various embodiments, each resource of the plurality of resources within the pool of resources is unique.

At procedure 440, the owner node allocates the resource from the pool of resources comprising a plurality of resources. At procedure 450, an allocation marker corresponding to the resource is created. In one embodiment, the allocation marker includes a time stamp. In one embodiment, at procedure 452, the resource and the allocation marker are saved in the database in a single transaction, where the database is accessible by the consumer node for the retrieval of the resource and the allocation marker. At procedure 460, the resource and the allocation marker are made available for retrieval by the consumer node.

In one embodiment, the resource is retrieved by the consumer node, as illustrated in FIG. 4B. At procedure 480, the resource is received at the consumer node. At procedure 482, the resource is saved in a resource allocation table (e.g., resource allocation table 260) at the consumer node and the allocation marker is deleted from the database in a single transaction. By deleting the allocation marker and the saving the resource in a resource allocation table at the consumer node in a single transaction, the described embodiments protect against resource leakage by ensuring that the allocation is received at the consumer node while deleting the allocation marker.

In one embodiment, the resource is not retrieved by the consumer node, as illustrated in FIG. 4C. For example, this might occur where the consumer node has crashed subsequent to making the allocation request but prior to retrieving the allocation resource, or because throughput of the managed system is slow. At procedure 490, it is determined whether an expiry interval after the time stamp of the allocation marker has lapsed. For example, the expiry interval is 5 minutes. As such, the consumer node would have to retrieve the resource within 5 minutes of the resource being made available for retrieval. It should be appreciated that an expiry interval may be used.

Provided the resource is not retrieved by the consumer node before the expiry interval after the time stamp lapses, as shown at procedure 492, the resource is returned to the pool of resources, such that the resource is available for allocation. This allows for protection against resource leakage by ensuring that allocated and unused resources are returned to the pool of resources for reallocation. Provided the expiry interval after the time stamp has not lapsed, as shown at procedure 494, the cleanup operation is paused and then returns to procedure 490.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for managing resource allocation of a managed system, the method comprising:
responsive to a request by a consumer node for a resource from a pool of resources, determining an owner node of a plurality of owner nodes that controls resource allocations from the pool of resources, wherein the resource is associated with a data object;
allocating, by the owner node, the resource from the pool of resources comprising a plurality of resources;
creating an allocation marker corresponding to the resource; and
making the resource and the allocation marker available for retrieval by the consumer node.

2. The method of claim 1, wherein the resource is one of an Internet Protocol (IP) address, a media access control (MAC) address, and a device identifier.

3. The method of claim 1, further comprising:
receiving the resource at the consumer node; and
deleting the allocation marker.

4. The method of claim 3, further comprising:
saving the resource in a resource allocation table at the consumer node.

5. The method of claim 4, wherein the deleting the allocation marker and the saving the resource in a resource allocation table at the consumer node are performed in a single transaction.

6. The method of claim 1, further comprising:
saving the resource and the allocation marker in a database in a single transaction, wherein the database is accessible by the consumer node for the retrieval of the resource and the allocation marker.

7. The method of claim 1, wherein the managed system comprises a plurality of owner nodes, wherein each owner node controls allocation of resources from a designated pool of resources.

8. The method of claim 7, further comprising:
receiving the request by the consumer node to allocate the resource from the pool of resources at a database; and
communicating a change notification to the plurality of owner nodes, wherein the change notification comprises the request.

9. The method of claim 8, wherein the determining an owner node of a plurality of owner nodes that controls resource allocations from the pool of resources is performed at each owner node of the plurality of owner nodes in response to the plurality of owner nodes receiving the change notification.

10. The method of claim 1, wherein each resource of the plurality of resources within the pool of resources is unique.

11. The method of claim 1, wherein the allocation marker comprises a time stamp.

12. The method of claim 11, further comprising:
provided the resource is not retrieved by the consumer node before lapsing of an expiry interval after the time stamp, returning the resource to the pool of resources, such that the resource is available for allocation.

13. A non-transitory computer readable storage medium having computer readable program code stored thereon for causing a computer system to perform a method for managing resource allocation of a managed system, the method comprising:
responsive to a request by a consumer node for a resource from a pool of resources, determining an owner node of a plurality of owner nodes that controls resource allocations from the pool of resources, wherein the resource is associated with a data object;
allocating, by the owner node, the resource from the pool of resources comprising a plurality of resources, wherein each resource of the plurality of resources within the pool of resources is unique;
creating an allocation marker corresponding to the resource, wherein the allocation marker comprises a time stamp;
receiving the resource at the consumer node; and
deleting the allocation marker.

14. The non-transitory computer readable storage medium of claim 13, the method further comprising:
saving the resource in a resource allocation table at the consumer node.

15. The non-transitory computer readable storage medium of claim 14, wherein the deleting the allocation marker and the saving the resource in a resource allocation table at the consumer node are performed in a single transaction.

16. The non-transitory computer readable storage medium of claim 13, the method further comprising:
saving the resource and the allocation marker in a database in a single transaction, wherein the database is accessible by the consumer node for retrieval of the resource and the allocation marker.

17. The non-transitory computer readable storage medium of claim 13, wherein the managed system comprises a plurality of owner nodes, wherein each owner node controls allocation of resources from a designated pool of resources, the method further comprising:
receiving the request by the consumer node to allocate the resource from the pool of resources at a database; and
communicating a change notification to the plurality of owner nodes, wherein the change notification comprises the request.

18. The non-transitory computer readable storage medium of claim 17, wherein the determining an owner node of a plurality of owner nodes that controls resource allocations from the pool of resources is performed at each owner node of the plurality of owner nodes in response to the plurality of owner nodes receiving the change notification.

19. A computer system comprising:
a data storage unit; and
a processor coupled with the data storage unit, the processor configured to:
determine an owner node of a plurality of owner nodes of a managed system that controls resource allocations from a pool of resources in response to a request by a consumer node for a resource from the pool of resources, wherein the resource is associated with a data object;
allocate the resource from the pool of resources comprising a plurality of resources, wherein each resource of the plurality of resources within the pool of resources is unique;
create an allocation marker corresponding to the resource;
save the resource and the allocation marker in a database, wherein the database is accessible by the consumer node for retrieval of the resource and the allocation marker by the consumer node;
receive the resource at the consumer node; and
save the resource in a resource allocation table at the consumer node and delete the allocation marker in a single transaction.

20. The computer system of claim 19, wherein the managed system comprises a plurality of owner nodes, wherein each owner node controls allocation of resources from a designated pool of resources.

21. The computer system of claim 20, wherein the processor is further configured to:
receive the request by the consumer node to allocate the resource from the pool of resources at a database; and
communicate a change notification to the plurality of owner nodes, wherein the change notification comprises the request.

22. The computer system of claim 21, wherein the processor is further configured to:
determine, at each of the plurality of owner nodes, which owner node of the plurality of owner nodes that controls allocation of resources from the pool of resources in response to the plurality of owner nodes receiving the change notification.
